(19) United States
(12) Patent Application Publication
(10) Pub. No.: US 2012/0226629 A1
(43) Pub. Date: Sep. 6, 2012

(54) System and Method For Multiple Frozen-Parameter Dynamic Modeling and Forecasting

(76) Inventor: Narindra N. Puri, Monmouth Junction, NJ (US)

(21) Appl. No.: 13/408,122

(22) Filed: Feb. 29, 2012

Related U.S. Application Data
(60) Provisional application No. 61/448,598, filed on Mar. 2, 2011.

(51) Int. Cl. G06Q 10/04; G06F 17/10; G06Q 40/06

(52) U.S. Cl. 705/36 R; 703/6; 703/2

(57) ABSTRACT

A system and method is disclosed for determining multiple frozen-parameter dynamic modeling and forecasting of future data values from data values in a data set. Model parameter values are dynamically updated utilizing a time-varying system property, and an updated model is optimally evolved that takes into account the structural changes that may have influenced the actual process, thereby yielding a superior modeling capability. The resultant model is updated in a closed-loop manner. In one exemplary embodiment, the data set comprises financial portfolio data. In another exemplary embodiment, the data set comprises seismic data.

### CROSS-REFERENCE TO RELATED PATENT APPLICATION

The present patent application is related to U.S. Provisional Patent Application Ser. No. 61/448,598, filed Mar. 2, 2011, entitled “Multiple Frozen-Parameter Dynamic Modeling And Forecasting Algorithm,” invented by N. N. Puri, the disclosure of which being incorporated by reference herein.

### BACKGROUND

Mathematical methods developed in last 20 years have played an important role in the study of economics and financial markets. The mathematical methods are possible because of cheap and ample computing resources being available at will. Nevertheless, even the most powerful computational facilities have limitations if the amount of the data is astronomical and the system dynamics are changing continuously. Many ideas relating to dynamic modeling and forecasting algorithms were developed during the hay days of Aerospace advances. In the existing methods in the literature, the portfolio model parameters are determined from the incoming data and then passively used to predict the future portfolio values.

For example, Box and Jenkins popularized a three-stage method aimed at selecting an appropriate ARIMA(p,q), model for the purpose of estimating and forecasting a time series in which p is the order of the system and q represents the number of error terms. This was characterized as model identification, i.e., deciding on the order of p,q, estimation involving the parameter fitting in the ARIMA model. The time-series modeling capabilities for linear regression models by ARIMA have been extensively used by the Census Bureau. Nevertheless, the methodology of Box and Jenkins does not provide a dynamically updated scheme.

### BRIEF DESCRIPTION OF THE DRAWINGS

The subject matter disclosed herein is illustrated by way of example and not by limitation in the accompanying figures in which like reference numerals indicate similar elements and in which:

FIG. 1 depicts one exemplary embodiment of a flow diagram of the Dynamic Modeling and Forecasting Algorithm (DMFA) according to the subject matter disclosed herein;

FIGS. 2-5 depict graphical comparisons between actual Standard & Poor's 500 values and predicted values for different m and n;

FIG. 6 depicts an exemplary embodiment of an article of manufacture comprising a non-transitory computer-readable medium having stored thereon instructions that, if executed, result in at least the subject matter disclosed herein; and

FIG. 7 depicts a functional block diagram of one exemplary embodiment of an information-handling system capable of providing multiple frozen-parameter dynamic modeling and forecasting according to the subject matter disclosed herein.

### DETAILED DESCRIPTION

As used herein, the word “exemplary” means “serving as an example, instance, or illustration.” Any embodiment described herein as “exemplary” is not to be construed as necessarily preferred or advantageous over other embodiments. Additionally, it will be appreciated that for simplicity and/or clarity of illustration, elements illustrated in the figures have not necessarily been drawn to scale. For example, the dimensions of some of the elements may be exaggerated relative to other elements for illustrative clarity. Further, in some figures only one or two of a plurality of similar elements indicated by reference characters for illustrative clarity of the figure, whereas all of the similar element may not be indicated by reference characters. Further still, it should be understood that although some portions of components and/or elements of the subject matter disclosed herein have been omitted from the figures for illustrative clarity, good engineering, construction and assembly practices, are intended.

The subject matter disclosed herein relates to a system and method for determining multiple frozen-parameter dynamic modeling and forecasting, which is a technique referred to herein as the Dynamic Modeling and Forecasting Algorithm (DMFA). More specifically, the subject matter disclosed herein provides an advantage of dynamically updating the model parameter values utilizing a time-varying system property and evolving an optimally updated model that takes into account the structural changes that may have influenced the actual process, thereby yielding a superior modeling capability. The resultant model is updated in a closed-loop manner.

The technique of the subject matter disclosed herein, unlike ARIMA, is dynamic and has many applications across diverse fields, such as aerospace, seismography, and stock-bond portfolio valuation and optimization. For example, in aerospace engineering, the predicted model can be used to make corrections of control system parameters. As another example in seismography, earth-quake predictions are an immensely useful tool, and the model determined by the subject matter disclosed herein can be used as a powerful predictor of an impending disaster. For a stock and bond portfolio, the projections of variable vectors (such as interest rates, home price index appreciation, forex-rates, swaps) can be modeled by the subject matter disclosed herein for portfolio valuation and optimization and used for buying/selling individual entities for a well-balanced portfolio. In a nut-shell, the subject matter disclosed herein relates to a technique for dynamically computing the “frozen” parameters from existing data and predicting the next data point. A recursive matrix inversion algorithm results in an efficient computation. Moreover, the subject matter disclosed herein can be extended to provide an optimal allocation of capital resources. One of the major drawbacks that comes with trading complicated financial instruments, such as options and financial derivatives, is extreme volatility. The subject matter disclosed herein can be used to dynamically predict the volatility parameter, which can be used in Black-Scholes equations for option trading. Additionally, the subject matter disclosed herein provides a methodology to compute optimal option pricing and the most profitable mortgages for a hedge fund portfolio.

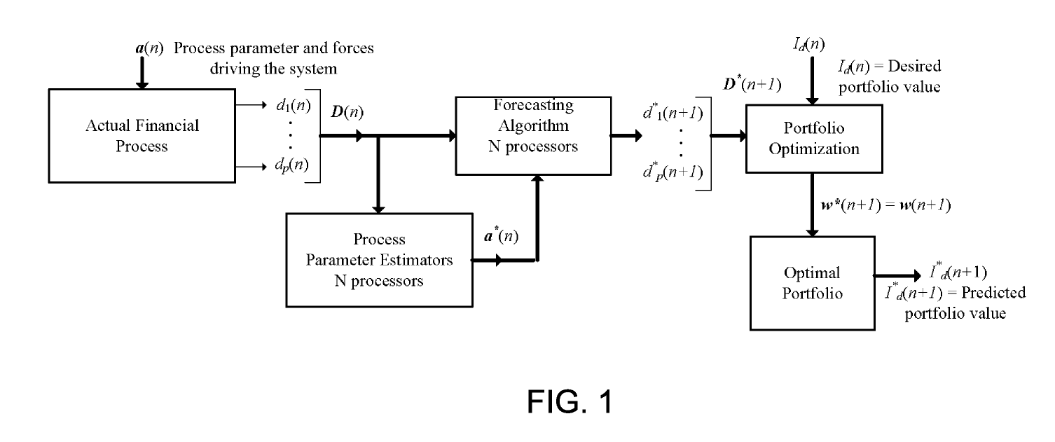

FIG. 1 depicts one exemplary embodiment of the Dynamic Modeling and Forecasting Algorithm (DMFA) according to the subject matter disclosed herein. Given a data set {d(i)}ᵢ₌₀ⁿ, an (m+1) parameter filter can be designed such that (n−k)≧(2m+1), in which k represents a minimum number of initial samples required before prediction can begin. The (m+1) filter parameters depend upon the instant n and are considered “frozen” in the sense that they are considered as constant from instant k to n, and thereafter time varying, dependent on n, and dynamically computed and updated. The starting instant k can be varied depending upon the conditions of the modeled process.

Filter Dynamic Model

The modeling process provided by the subject matter disclosed herein is defined as:

d(n+i−l)=a₀(n)+d(n−i−l)aₗ(n)+ . . . +d(n+1−i−l m)aₘ(n)+εₗ(n) for i=0, 1, 2, . . . , n−k; l=1, 2, . . . , m+1; n≧k+2m+1, k≧2m+1. (1)

The coefficients {aᵢ(n)}ₗ₌₁^{m+1} represent the filter model parameters. The variables {εᵢ(n)}ᵢ₌ₖⁿ represent random noise having zero mean and being uncorrelated with the data (a practical assumption).

Let

d(n+1−i−l)−d(n+1−i−l−1)=x(n+1−i−l)εᵢ(n+1)−εᵢ(n)=ηᵢ(n). (2)

Equation 2 yields m equations involving m parameters {aᵢ(n)}ₗ₌₁^{m+1}. The parameter a₀(m) is eliminated, but will be recovered later. From Eq. 1 and 2, the resulting equations are:

$$x ( n + 1 - i - l ) = {\sum }_{j = 1}^{m} x ( n + 1 - i - l - j ) {a}_{j} ( n ) + {η}_{i} ( n ) , \\ l = 1 , 2 , … , m ; \\ i = k , k + 1 , … , n . \qquad ( 3 )$$

Multiplying Eq. 3 by x(n−i) and summing from i=0 to i=n−k, we obtain

$$\begin{matrix}{\sum }_{i = 0}^{n - k} [ x ( n - i ) x ( n + 1 - i - l ) ] = {\sum }_{j = 1}^{m} {\sum }_{i = 0}^{n - k} [ x ( n - i ) x ( n + 1 - i - l j ) ] {a}_{j} ( n ) + {\sum }_{i = 0}^{n = k} [ x ( n - i ) {η}_{i} ( n ) ] . \\ Let & ( 4 ) \\ {\sum }_{i = 0}^{n - k} x ( n - i ) x ( n + 1 - i - l ) = {γ}_{i - 1} ( n ) , \\ {\sum }_{i = 0}^{n - k} [ x ( n - i ) x ( n + 1 - i - l - j ) ] = {γ}_{j + 1 - 1} ( n ) \\ for l = 1 , 2 , … , m ; j = 1 , 2 , … , m . \\ {\sum }_{i = 0}^{n - k} x ( n - i ) {η}_{i} ( n ) \approx 0 ( Data , a noise , being uncorrelated ) \\ or \\ [ \begin{matrix}{γ}_{0} ( n ) \\ {γ}_{1} ( n ) \\ ⋮ \\ {γ}_{m - 1} ( n )\end{matrix} ] = [ \begin{matrix}{γ}_{1} ( n ) & {γ}_{2} ( n ) & & {γ}_{m} ( n ) \\ {γ}_{2} ( n ) & {γ}_{3} ( n ) & & {γ}_{m + 1} ( n ) \\ ⋮ & ⋮ & … & ⋮ \\ {γ}_{m} ( n ) & {γ}_{m + k} ( n ) & & {γ}_{2 m - 1} ( n )\end{matrix} ] [ \begin{matrix}{a}_{1} ( n ) \\ {a}_{2} ( n ) \\ ⋮ \\ {a}_{m} ( n )\end{matrix} ] . & ( 5 )\end{matrix}$$

Index k can be made variable for each n as long as k≧2m+1. In fact, k can be increased as n increases.

Equation 5 can be rewritten in matrix-variable form:

γ(n)=Γ(n)a(n) (6)

in which γ(n), Γ(n) and a(n) are defined in Eq. 5. Matrix Γ(n) is a well-known Hankel matrix and has many interesting properties including recursive inversion algorithms for large values of m.

Updated parameter vector computation and prediction Eq. 6 results in the optimal evaluation of parameter vector a*ₘ(n) as follows:

a*(n)=(Γ(n))⁻¹ γ(n) (7a)

or

a*(n)=(Γ^{T}(n)Γ(n))⁻¹ Γ^{T}(n)γ(n). (7b)

Implementation of Eq. 7b in real time is very computation and storage intensive. A major contribution of the DMFA is a practical and computationally efficient solution of Eq. 7a and 7b.

Equations 7a and 7b yield the prediction algorithm:

x*(n+1)=x(n)a*₁(n)+x(n−1)a*₂(n)+ . . . +x(n−m)a*ₘ(n) (8)

in which x*(n+1) is the predicted value of the future data value x(n+1), which is still not available. Accordingly,

γ₁(n+1)=γₗ₊₁(n)=x(n+1)x(n+2−l), l=1, 2, . . . , m.

The parameter a₀(n) is obtained as:

$${a}_{0}^{*} ( n ) = [ \frac{\begin{matrix}{\sum }_{i = 0}^{n - k} [ x ( n - i ) d ( n + 1 - i ) ] - \\ {\sum }_{j = 1}^{m} ( {\sum }_{i = 0}^{n - k} [ x ( n - i ) d ( n + i - j ) ] )\end{matrix}}{{\sum }_{i = 0}^{n - k} x ( n - i )} ] . \qquad ( 9 )$$

The predicted data point at (n+1) is:

$${d}^{*} ( ( n + 1 ) / n ) = {a}_{0}^{*} ( n ) + {\sum }_{j = 1}^{m} d ( n + 1 - j ) {a}_{j}^{*} ( n ) \\ ( one \text{-} step prediction ) \qquad ( 10 )$$

The term “d*((n+1)/n)” represents the predicted value of d(n+1) given the data {d(i)}ᵢ₌ₖⁿ. An r-step prediction value can be computed as:

$${d}^{*} ( ( n + r ) / n ) = {a}_{0}^{*} ( n ) + {\sum }_{j = 1}^{m} {d}^{*} ( n + r - j ) {a}_{j}^{*} ( n ) \\ ( r \text{-} step prediction ) . \qquad ( 11 )$$

Index k is flexible and can be changed depending upon the process as it unfolds. In the case of a portfolio of more than one entity, Eq. 6 can be rewritten as:

γₚ(n)=Γₚ(n)aₚ(n). (12)

Portfolio Optimization

The DMFA provides a major advance in optimal resource allocation, as described herein. A portfolio consisting of different entities having a structure that is modeled by Eq. 1 and future values forecasted by Eq. 11 can be optimized as follows:

Let

y_{d}(n+1)=Desired value of the portfolio at time (n+1);

p=the index for a respective of portfolio entity;

P=the number of portfolio entities;

d*ₚ((n+r)/n)=Forecasted values of entities, p=1, 2, . . . , P; r=1, 2, . . . , R; and

wₚ(n)=Weighting of the entitles in the portfolio, p=1, 2, . . . , P.

The value of the portfolio at instance n is:

$$I ( n ) = {\sum }_{p = 1}^{P} {d}_{p} ( n ) {w}_{p} ( n ) \qquad ( 13 )$$

The problem at hand is to compute optimal value of wₚ(n+1) such that the portfolio value yields the desired value. Depending on the market condition with interest rate α, the desired portfolio value can be chosen as I_{d}((n+r)/n)=I(n)e^{arδt}, in which δt is a time interval between data samples, and α is the interest rate.

r is chosen to be greater than the number of entities p in the portfolio and the following portfolio optimization algorithm is arrived at:

$$\begin{matrix}[ \begin{matrix}{I}_{d} ( ( n + 1 ) / n ) \\ {I}_{d} ( ( n + 2 ) / n ) \\ ⋮ \\ {I}_{d} ( ( n + R ) / n )\end{matrix} ] = [ \begin{matrix}{d}_{1}^{*} ( ( n + 1 ) / n ) & {d}_{2}^{*} ( ( n + 1 ) / n ) & … & {d}_{p}^{*} ( ( n + 1 ) / n ) \\ {d}_{1}^{*} ( ( n + 2 ) / n ) & {d}_{2}^{*} ( ( n + 2 ) / n ) & … & {d}_{p}^{*} ( ( n + 2 ) / n ) \\ ⋮ & ⋮ & ⋮ & ⋮ \\ {d}_{1}^{*} ( ( n + R ) / n ) & {d}_{2}^{*} ( ( n + R ) / n ) & … & {d}_{p}^{*} ( ( n + R ) / n )\end{matrix} ] [ \begin{matrix}{w}_{1} ( n + 1 ) \\ {w}_{2} ( n + 2 ) \\ ⋮ \\ {w}_{p} ( n + R )\end{matrix} ] \\ or & ( 14 a ) \\ I ( ( n + 1 ) / n ) = [ {D}^{*} ( ( n + 1 ) / n ) ] {w}_{p} ( n + 1 ) & ( 14 b )\end{matrix}$$

The optimal weights wₚ(n+1) are computed as

w*ₚ(n+1)=[D*^{T}((n+1)/n)D*((n+1)/n)]⁻¹ D*^{T}((n+1)/n)I((n+1)/n). (15)

FIG. 1 depicts one exemplary embodiment of a flow diagram of the subject matter disclosed herein.

Thus, the DMFA technique disclosed herein is a superior auto regression (AR) model as a general system of time-series realizations in order to calculate the coefficients that fit the model for a better prediction. The system is solved via an inversion technique that avoids explicit inversion of more than a 2×2 matrix and computation of higher-dimensional determinants and co-factors. Furthermore, large number of parameters can be updated and the model re-fitted to reduce prediction errors. The technique can be further extended to solve for a financial portfolio involving a plurality of securities. The minimum mean-square algorithm used assures system stability by having poles within the unit circle. The matrix inversion implementation by the subject matter disclosed herein is a significant advancement.

The minimum mean square algorithm has been used for predicting, updating and optimizing a portfolio. Other optimization algorithms, such as linear programming, non-linear programming and dynamic programming, could also be used to arrive at other algorithms for optimal forecast.

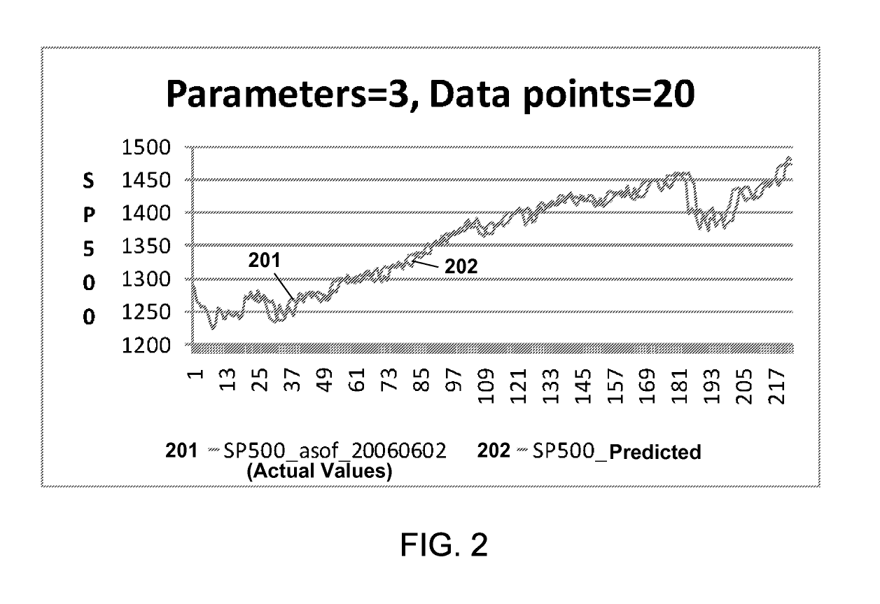

In an over-determined system, increasing n increases estimation errors for the same number of parameters m. Furthermore, increasing the number of parameters m tends to confuse a system as information is inferred from a larger number of past states, thereby leading to inaccurate tracking for a system that is inherently a lower-order system than assumed. This anomaly results in singular system matrices. An optimal m; n for a given input series may vary for a different input data time series. FIGS. 2-5 present comparisons between actual Standard and Poor's 500 values and predicted values for different m and n. Accordingly, parallel computing is a powerful tool when the number of securities is large. The optimal values for the quantities m and n may require some fine tuning for each particular situation.

In FIG. 2, curve 201 represents actual index data for the S&P 500 as of Jun. 2, 2006, and curve 202 represents predicted data provided by the Dynamic Modeling and Forecasting Algorithm (DMFA) disclosed herein. The abscissa of FIG. 2 represents time and the ordinate of FIG. 2 is the S&P 500 index actual and predicted values. Prediction curve 202 utilizes three (3) parameters and 20 data points.

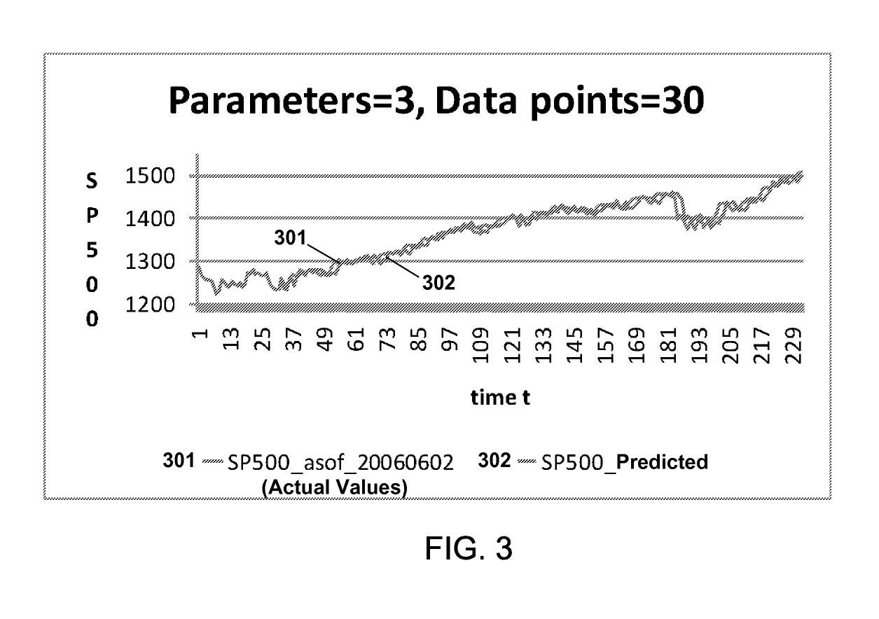

In FIG. 3, curve 301 represents actual index data for the S&P 500 as of Jun. 2, 2006, and curve 302 represents predicted data provided by the Dynamic Modeling and Forecasting Algorithm (DMFA) disclosed herein. The abscissa of FIG. 3 represents time and the ordinate of FIG. 3 is the S&P 500 index actual and predicted values. Prediction curve 302 utilizes three (3) parameters and 30 data points.

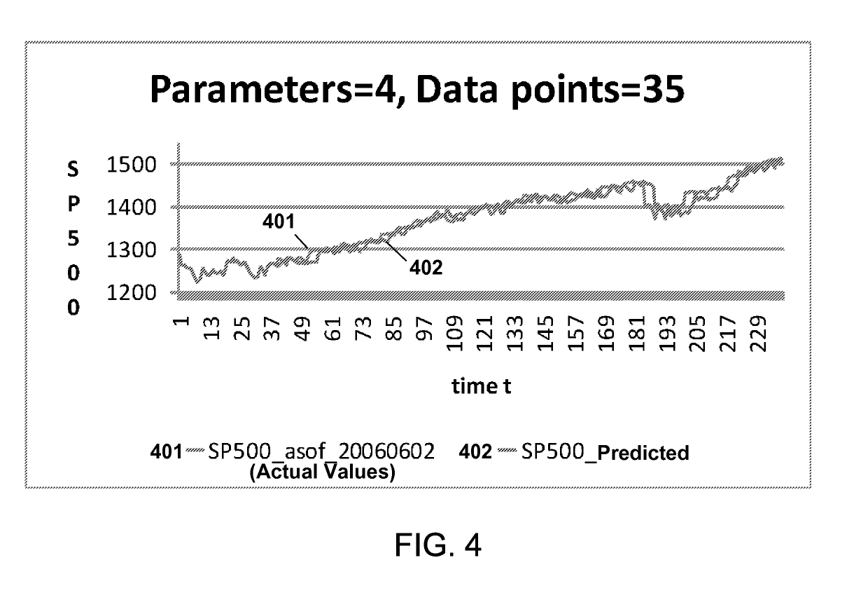

In FIG. 4, curve 401 represents actual index data for the S&P 500 as of Jun. 2, 2006, and curve 402 represents predicted data provided by the Dynamic Modeling and Forecasting Algorithm (DMFA) disclosed herein. The abscissa of FIG. 4 represents times and the ordinate of FIG. 4 is the S&P 500 index actual and predicted values. Prediction curve 402 utilizes four (4) parameters and 35 data points.

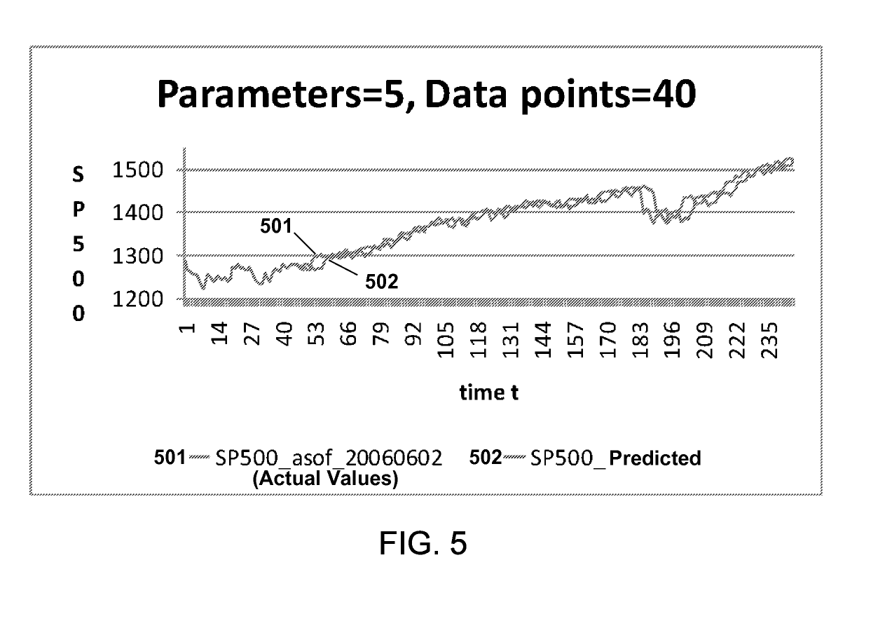

In FIG. 5, curve 501 represents actual index data for the S&P 500 as of Jun. 2, 2006, and curve 502 represents predicted data provided by the Dynamic Modeling and Forecasting Algorithm (DMFA) disclosed herein. The abscissa of FIG. 5 represents times and the ordinate of FIG. 5 is the S&P 500 index actual and predicted values. Prediction curve 502 utilizes five (5)5 parameters and 40 data points.

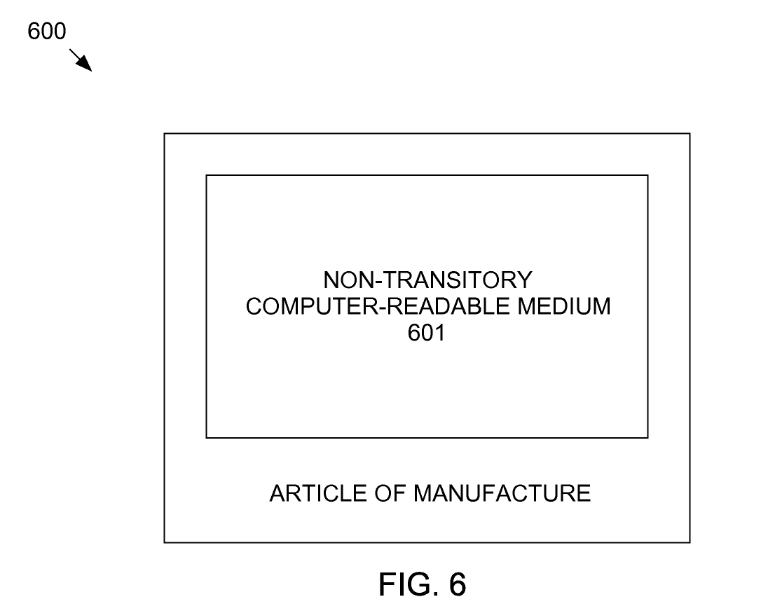

FIG. 6 depicts an exemplary embodiment of an article of manufacture 600 comprising a non-transitory computer-readable medium 601 having stored thereon instructions that, if executed, result in at least the subject matter disclosed herein. In one exemplary embodiment, computer-readable medium 601 comprises a magnetic computer-readable medium. In another exemplary embodiment, computer-readable medium 601 comprises an optical computer-readable medium. In yet other exemplary embodiments, computer-readable medium comprises a flash memory, a phase-change memory, and/or a chalcogenide-type memory or the like.

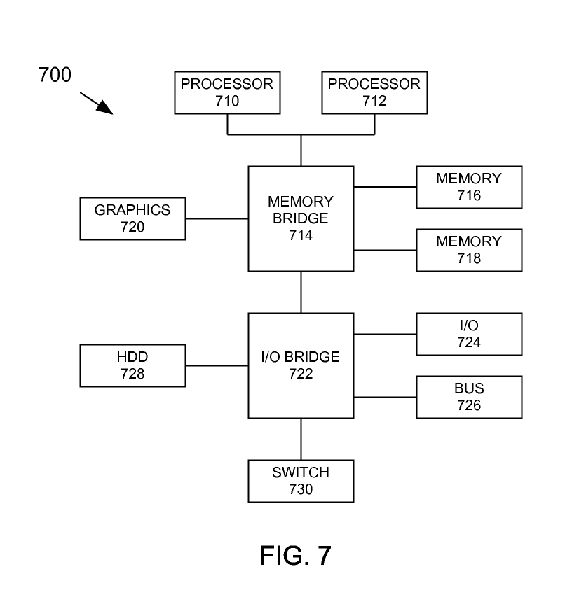

FIG. 7 depicts a functional block diagram of one exemplary embodiment of an information-handling system 700 capable of determining multiple frozen-parameter dynamic modeling and forecasting according to the subject matter disclosed herein. Information-handling system 700 may tangibly embody any of several types of computing platforms. Additionally, information-handling system 700 may include more or fewer elements and/or different arrangements of elements than shown in FIG. 7, and the scope of the claimed subject matter is not limited in these respects.

Information-handling system 700 may comprise one or more processors, such as processors 710 and/or processor 712, of which one or more may comprise one or more processing cores. In one exemplary embodiment, processors 710 and 712 are coupled to one or more memories 716 and/or 718 via a memory bridge 714, which may be disposed external to processors 710 and/or 712, or alternatively at least partially disposed within one or more of processors 710 and/or 712. Memory 716 and/or memory 718 may comprise various types of semiconductor-based memory, for example, a volatile-type memory and/or a nonvolatile-type memory. In one exemplary embodiment, memory bridge 714 may couple to a graphics system 720 to drive a display device (not shown) coupled to information-handling system 700.

Information-handling system 700 may further comprise an input/output (I/O) bridge 722 to couple to various types of I/O systems. I/O system 724 may comprise, for example, a universal serial bus (USB)-type system, an IEEE 1394-type system, or the like, to couple one or more peripheral devices to information-handling system 700. A Bus system 726 may comprise one or more bus systems, such as a peripheral component interconnect (PCI) express-type bus or the like, to connect one or more peripheral devices to information-handling system 700. A hard disk drive (HDD) controller system 728 may couple one or more hard disk drives, or the like, to information-handling system 700, such as, a Serial ATA-type drive or the like, or alternatively a semiconductor-based drive comprising flash memory, phase-change memory, and/or chalcogenide-type memory or the like. A switch 730 may be utilized to couple one or more switched devices to I/O bridge 722, for example, Gigabit Ethernet-type devices or the like.

Appendices

Appendix 1.

Given γ(n) and Γ(n), the vector a(n) is chosen to minimize

I=(Γ(n)a(n)−γ(n))^{T}(Γ(n)a(n)−γ(n)).

This minimization results in:

a*(n)=(Γ^{T}(n)Γ(n))⁻¹ Γ^{T}(n)γ(n) (16)

Implementation of Eq. 16 in real time is very computation intensive. In contrast, the DMFA technique disclosed herein provides a practical and computationally efficient solution.

Let

[Γ^{T}(n)Γ(n)]=B(n) (a symmetric matrix).

Γ^{T}(n)γ(n)=z(n)

yielding

a^{T}(n)=B⁻¹(n)z(n).

Appendix 2. Derivation of Recursive Algorithm for solution of B⁻¹(n).

Let

$$B \text{?} ( n ) = [ \begin{matrix}{b}_{11} ( n ) & … & b \text{?} ( n ) \\ & ⋮ & \\ b \text{?} ( n ) & … & b \text{?} ( n )\end{matrix} ] \text{?} , \\ B \text{?} ( n ) = [ \begin{matrix}{b}_{11} ( n ) & … & b \text{?} ( n ) \\ & ⋮ & \\ b \text{?} ( n ) & … & b \text{?} ( n )\end{matrix} ] \text{?} . \\ \text{?} \text{indicates text missing or illegible when filed}$$

Define

$$B \text{?} ( n ) = [ \begin{matrix}B \text{?} ( n ) & c \text{?} ( n ) \\ c \text{?} ( n ) & b \text{?} ( n )\end{matrix} ] , c \text{?} ( n ) = [ \begin{matrix}b \text{?} ( n ) \\ ⋮ \\ b \text{?} ( n )\end{matrix} ] \\ B \text{?} ( n ) = [ \begin{matrix}A \text{?} ( n ) & e \text{?} ( n ) \\ e \text{?} ( n ) & f \text{?} ( n )\end{matrix} ] , \\ B \text{?} ( n ) B \text{?} ( n ) = I \text{?} Identity Matrix \\ yielding \\ \begin{matrix}B \text{?} ( n ) A \text{?} ( n ) + c \text{?} ( n ) = I ( Identity matrix ) \\ B \text{?} ( n ) e \text{?} ( n ) + c \text{?} ( n ) f \text{?} ( n ) = 0 \\ c \text{?} ( n ) e \text{?} ( n ) + b \text{?} ( n ) f \text{?} ( n ) = 1\end{matrix} \} . \\ \text{?} \text{indicates text missing or illegible when filed} \qquad ( 1.7 )$$

Let

Bₗ⁻¹cₗ₊₁(n)=gₗ₊₁(n). (18)

The solution of Eq. 17 is:

eₗ₊₁(n)=−(fₗ₊₁(n)gₗ₊₁(n)

fₗ₊₁(n)=(b_{l+1,l+1}−cₗ₊₁^{T}(n)gₗ₊₁(n))⁻¹

Aₗ₊₁(n)=Bₗ⁻¹(n)+fₗ₊₁(n)(gₗ₊₁(n)gₗ₊₁^{T}(n)).

Thus, Bₗ₊₁⁻¹(n) is computed from Bₗ⁻¹(n) and Bₗ₊₁(n). When l=m, the process is terminated. The implementation disclosed herein represents a major advance for providing a practical and computationally efficient solution.

Appendix 3.

Given:

B(n+1)=(B(n)+Δ(n))

Let

((B(n+0)⁻¹=(B(n)+Δ(n))⁻¹=(B(n)+εΔ(n))⁻¹, ε=1.

From Taylor series,

$${( B ( n ) + ɛΔ ( n ) )}^{- 1} = {T}_{0} ( n ) + ɛ {T}_{1} ( n ) + {ɛ}^{2} {T}_{2} ( n ) + … = {\sum }_{i = 0}^{∞} {ɛ}^{( i )} {T}_{i} ( n )$$

$$or \\ ( {\sum }_{i = 0}^{∞} {ɛ}^{( i )} {T}_{i} ( n ) ) ( B ( n ) + ɛΔ ( n ) ) = I .$$

Equating powers of ε,

Tᵢ(n)=(−1)ⁱTᵢ₋₁(n)Δ(n)B⁻¹(n), i=1, 2, . . .

T₀(n)=B⁻¹(n).

For

$$\frac{\vert Δ ( n ) \vert}{\vert B ( n ) \vert} ≪ 1$$

$${B}^{- 1} ( n + 1 ) \approx {B}^{- 1} ( n ) - {B}^{- 1} ( n ) Δ ( n ) {B}^{- 1} ( n ) .$$

Although the foregoing disclosed subject matter has been described in some detail for purposes of clarity of understanding, it will be apparent that certain changes and modifications may be practiced that are within the scope of the disclosed subject matter. Accordingly, the exemplary embodiments are to be considered as illustrative and not restrictive, and the subject matter disclosed herein is not to be limited to the details given herein, but may be modified within the scope and equivalents of the present disclosure.

What is claimed is:

1. A system comprising:
an input/output (I/O) device capable of receiving information relating to a data set; and
a processing device coupled to the I/O device, the processor capable of determining a predicted future value of a data point by:
defining a predicted data value for a future data value d(n+1) of a current data point d(n) as d*((n+1)/n), in which the current data point d(n) is part of the data set, the data set comprises {d(i)}ᵢ₌ₖⁿ and k comprises a minimum number of initial samples required before prediction can begin;
setting
d(n+i−l)=a₀(n)+d(n−i−l)a₁(n)+ . . . +d(n+1−i−l m)aₘ(n)+εᵢ(n)
in which i=0, 1, 2, . . . , n−k, l=1, 2, . . . , m+1, n≧k+2m+1, k≧2m+1, coefficients {aᵢ(n)}ₗ₌₁^{m+1} comprise a parameter process, and variables {εᵢ(n)}ᵢ₌ₖⁿ comprise random noise having zero mean and being uncorrelated with the data d(n) in the data set;
determining
x(n+1−i−l)=d(n+1−i−l)−d(n+1−i−l−1), and
ηᵢ(n)=εᵢ(n+1)−εᵢ(n);
determining
$$x ( n + 1 - i - l ) = {\sum }_{j = 1}^{m} x ( n + 1 - i - l - j ) {a}_{j} ( n ) + {η}_{i} ( n )$$
for l=1, 2, . . . , m, and i=k, k+1, . . . n;
multiplying x(n+1−i−l) by x(n−i) and summing from i=0 to i=n−k to obtain
$${\sum }_{i = 0}^{n - k} [ x ( n - i ) x ( n + 1 - i - l ) ] = {\sum }_{j = 1}^{m} {\sum }_{i = 0}^{n - k} [ x ( n - i ) x ( n + 1 - i - l j ) ] {a}_{j} ( n ) + {\sum }_{i = 0}^{n = k} [ x ( n - i ) {η}_{i} ( n ) ] ;$$
$$setting$$
$${γ}_{i - 1} ( n ) = {\sum }_{i = 0}^{n - k} x ( n - i ) x ( n + 1 - i - l ) , and$$
$${γ}_{j + 1 - 1} ( n ) = {\sum }_{i = 0}^{n - k} [ x ( n - i ) x ( n + 1 - i - l - j ) ]$$
$$for l = 1 , 2 , … , m , and for j = 1 , 2 , ⋯ , m ;$$
$$setting$$
$${\sum }_{i = 0}^{n - k} x ( n - i ) {η}_{i} ( n ) \approx 0 ;$$
determining
x*(n+1)=x(n)a*₁(n)+x(n−1)a*₂(n)+ . . . +x(n−m)a*ₘ(n)
in which x*(n+1) is a predicted value of the future data value x(n+1);
setting
γₗ(n+1)=γₗ₊₁(n)=x(n+1)x(n+2−l)
for l=1, 2, . . . , m;
determining a predicted process parameter a*₀(n) as
$${a}_{0}^{*} ( n ) = [ \frac{{\sum }_{i = 0}^{n - k} [ x ( n - i ) d ( n + 1 - i ) ] - {\sum }_{j = 1}^{m} ( {\sum }_{i = 0}^{n - k} [ x ( n - i ) d ( n + i - j ) ] )}{{\sum }_{i = 0}^{n - k} x ( n - i )} ] ;$$
and
determining a predicted data point at (n+1) as:
$${d}^{*} ( ( n + 1 ) / n ) = {a}_{0}^{*} ( n ) + {\sum }_{j = 1}^{m} d ( n + 1 - j ) {a}_{j}^{*} ( n ) .$$

2. The system according to claim 1, wherein the data set comprises financial portfolio data of a portfolio, and
the processor further capable of:
setting a desired future value of the portfolio at time (n +1) to be y_{d} (n +1);
setting a forecasted value of a data point of an entity in the portfolio to be d*ₚ((n+r)/n) for p=1, 2, . . . , P, and r=1, 2, . . . , R, in which R is selected to be greater than setting a weighting of each entity in the portfolio to be wₚ (n) for p=1,2, . . . , P;
setting a current value of the portfolio at instance n to be
$$I ( n ) = {\sum }_{p = 1}^{P} {d}_{p} ( n ) {w}_{p} ( n ) ;$$
determining a desired portfolio value to be I_{d}((n+r)/n)=I(n)e^{arδt} in which δt is a time interval between data samples, and α is an interest rate; and
optimizing the entities in the portfolio as
$$[ \begin{matrix}{I}_{d} ( ( n + 1 ) / n ) \\ {I}_{d} ( ( n + 2 ) / n ) \\ ⋮ \\ {I}_{d} ( ( n + R ) / n )\end{matrix} ] = [ \begin{matrix}{d}_{1}^{*} ( ( n + 1 ) / n ) & {d}_{2}^{*} ( ( n + 1 ) / n ) & … & {d}_{p}^{*} ( ( n + 1 ) / n ) \\ {d}_{1}^{*} ( ( n + 2 ) / n ) & {d}_{2}^{*} ( ( n + 2 ) / n ) & … & {d}_{p}^{*} ( ( n + 2 ) / n ) \\ ⋮ & ⋮ & ⋮ & ⋮ \\ {d}_{1}^{*} ( ( n + R ) / n ) & {d}_{2}^{*} ( ( n + R ) / n ) & … & {d}_{p}^{*} ( ( n + R ) / n )\end{matrix} ] [ \begin{matrix}{w}_{1} ( n + 1 ) \\ {w}_{2} ( n + 2 ) \\ ⋮ \\ {w}_{p} ( n + R )\end{matrix} ]$$
or as
I((n+1)/n)=[D*((n+1)/n)]wₚ(n+1); and
determining an optimal weight w*ₚ(n+1) for each entity in the portfolio as
w*ₚ(n+1)=[D*^{T}((n+1)/n)D*((n+1)/n)]⁻¹D*^{T}((n+1)/n)I((n+1)/n).

3. The system according to claim 2, wherein the data set comprises financial portfolio data.

4. The system according to claim 1, wherein the data set comprises financial portfolio data.

5. The system according to claim 1, wherein the data set comprises seismic data.

6. A method for predicting a future value of a data point, the method comprising:
defining a predicted data value for a future data value d(n+1) of a current data point d(n) as d*((n+1)/n), in which the current data point d(n) is part of a data set {d(i)}ᵢ₌ₖⁿ and k comprises a minimum number of initial samples required before prediction can begin;
setting
d(n+i−l)=a₀(n)+d(n−i−l)a₁(n)+ . . . +d(n+1−i−l m)aₘ(n)+εᵢ(n)
in which i=0, 1, 2, . . . , n−k, l=1, 2, . . . , m+1, n≧k+2m+1, k≧2m+1, coefficients {aᵢ(n)}ₗ₌₁^{m+1} comprise a parameter process, and variables {εᵢ(n))ᵢ₌ₖⁿ comprise random noise having zero mean and being uncorrelated with the data d(n) in the data set;
determining
x(n+1−i−l)=d(n+1−i−l)−d(n+1−i−l−1), and
ηᵢ(n)=εᵢ(n+1)−εᵢ(n);
determining
$$x ( n + 1 - i - l ) = {\sum }_{j = 1}^{m} x ( n + 1 - i - l - j ) {a}_{j} ( n ) + {η}_{i} ( n )$$
for l=1, 2, . . . , m, and i=k, k+1, n;
multiplying x(n+1−i−l) by x(n−i) and summing from i=0 to i=n−k to obtain
$${\sum }_{i = 0}^{n - k} [ x ( n - i ) x ( n + 1 - i - l ) ] = {\sum }_{j = 1}^{m} {\sum }_{i = 0}^{n - k} [ x ( n - i ) x ( n + 1 - i - l j ) ] {a}_{j} ( n ) + {\sum }_{i = 0}^{n = k} [ x ( n - i ) {η}_{i} ( n ) ] ;$$
setting
$${γ}_{i - 1} ( n ) = {\sum }_{i = 0}^{n - k} x ( n - i ) x ( n + 1 - i - l ) , and$$
$${γ}_{j + 1 - 1} ( n ) = {\sum }_{i = 0}^{n - k} [ x ( n - i ) x ( n + 1 - i - l - j ) ]$$
for l=1, 2, . . . , m, and for j=1, 2, . . . , m;
setting
$${\sum }_{i = 0}^{n - k} x ( n - i ) {η}_{i} ( n ) \approx 0 ;$$
determining
x*(n+1)=x(n)a*₁(n)+x(n−1)a*₂(n)+ . . . +x(n−m)a*ₘ(n)
in which x*(n+1) is a predicted value of the future data value x(n+1);
setting
γₗ(n+1)=γₗ₊₁(n)=x(n+1)x(n+2−l)
for l=1, 2, . . . , m;
determining a predicted process parameter a*₀(n) as
$${a}_{0}^{*} ( n ) = [ \frac{{\sum }_{i = 0}^{n - k} [ x ( n - i ) d ( n + 1 - i ) ] - {\sum }_{j = 1}^{m} ( {\sum }_{i = 0}^{n - k} [ x ( n - i ) d ( n + i - j ) ] )}{{\sum }_{i = 0}^{n - k} x ( n - i )} ] ;$$
and
determining a predicted data point at (n+1) as:
$${d}^{*} ( ( n + 1 ) / n ) = {a}_{0}^{*} ( n ) + {\sum }_{j = 1}^{m} d ( n + 1 - j ) {a}_{j}^{*} ( n ) .$$

7. The method according to claim 6, wherein the data set comprises financial portfolio data of a portfolio,
the method further comprising:
setting a desired future value of the portfolio at time (n+1) to be γ_{d}(n+1);
setting a forecasted value of a data point of an entity in the portfolio to be d*ₚ((n+r) for p=1, 2, . . . , P, and r=1, 2, . . . , R, in which R is selected to be greater than
setting a weighting of each entity in the portfolio to be wₚ(n) for p=1, 2, . . . , P;
setting a current value of the portfolio at instance n to be
$$I ( n ) = {\sum }_{p = 1}^{P} {d}_{p} ( n ) {w}_{p} ( n ) ;$$
determining a desired portfolio value to be I_{d}((n+r)/n)=I(n)e^{arδt} in which δt is a time interval between data samples, and α is an interest rate; and
optimizing the entities in the portfolio as
$$[ \begin{matrix}{I}_{d} ( ( n + 1 ) / n ) \\ {I}_{d} ( ( n + 2 ) / n ) \\ ⋮ \\ {I}_{d} ( ( n + R ) / n )\end{matrix} ] = [ \begin{matrix}{d}_{1}^{*} ( ( n + 1 ) / n ) & {d}_{2}^{*} ( ( n + 1 ) / n ) & … & {d}_{p}^{*} ( ( n + 1 ) / n ) \\ {d}_{1}^{*} ( ( n + 2 ) / n ) & {d}_{2}^{*} ( ( n + 2 ) / n ) & … & {d}_{p}^{*} ( ( n + 2 ) / n ) \\ ⋮ & ⋮ & ⋮ & ⋮ \\ {d}_{1}^{*} ( ( n + R ) / n ) & {d}_{2}^{*} ( ( n + R ) / n ) & … & {d}_{p}^{*} ( ( n + R ) / n )\end{matrix} ] [ \begin{matrix}{w}_{1} ( n + 1 ) \\ {w}_{2} ( n + 2 ) \\ ⋮ \\ {w}_{p} ( n + R )\end{matrix} ]$$
or as
I((n+1)/n)=[D*((n+1)/n)]wₚ(n+1)
determining an optimal weight w*ₚ(n+1) for each entity in the portfolio as
w*ₚ(n+1)=[D*^{T}((n+1)/n)D*((n+1)/n)]⁻¹D*^{T}((n+1)/n)I((n−1)/n).

8. The method according to claim 7, wherein the data set comprises financial portfolio data.

9. The method according to claim 6, wherein the data set comprises financial portfolio data.

10. The method according to claim 6, wherein the data set comprises seismic data.

11. An article comprising: a non-transitory computer-readable medium having stored thereon instructions that, if executed, result in at least the following:
defining a predicted data value for a future data value d(n+1) of a current data point d(n) as d*((n+1)/n), in which the current data point d(n) is part of a data set {d(i)}ᵢ₌ₖⁿ and k comprises a minimum number of initial samples required before prediction can begin;
setting
d(n+i−l)=a₀(n)+d(n−i−l)a₁(n)+ . . . . +d(n+1−i−l m)aₘ(n)+εₗ(n)
in which i=0, 1, 2, . . . , n−k, l=1, 2, . . . , m+1, n≧k+2m+1, k≧2m+1, coefficients {aᵢ(n)}ₗ₌₁^{m+1} comprise a parameter process, and variables {εᵢ(n)}ₗ₌ₖⁿ comprise random noise having zero mean and being uncorrelated with the data d(n) in the data set;
determining
x(n+1−i−l)=d(n+1−i−l)−d(n+1−i−l−1), and
ηᵢ(n)=εᵢ(n+1)−εᵢ(n);
determining
$$x ( n + 1 - i - l ) = {\sum }_{j = 1}^{m} x ( n + 1 - i - l - j ) {a}_{j} ( n ) + {η}_{i} ( n )$$
for l=1,2, . . . , m, and i=k,k+1, . . . n;
multiplying x(n+1−i−l) by x(n−i) and summing from i=0 to i=n−k to obtain
$${\sum }_{i = 0}^{n - k} [ x ( n - i ) x ( n + 1 - i - l ) ] = {\sum }_{j = 1}^{m} {\sum }_{i = 0}^{n - k} [ x ( n - i ) x ( n + 1 - i - lj ) ] {a}_{j} ( n ) + {\sum }_{i = 0}^{n = k} [ x ( n - i ) {η}_{i} ( n ) ] ;$$
setting
$${γ}_{i - 1} ( n ) = {\sum }_{i = 0}^{n - k} x ( n - i ) x ( n + 1 - i - l ) , and$$
$${γ}_{j + 1 - 1} ( n ) = {\sum }_{i = 0}^{n - k} [ x ( n - i ) x ( n + 1 - i - l - j ) ]$$
for l=1, 2, . . . , m, and for j=1, 2, . . . , m;
setting
$${\sum }_{i = 0}^{n - k} x ( n - i ) {η}_{i} ( n ) \approx 0 ;$$
determining
x*(n+1)=x(n)a*₁(n)+x(n−1)a*₂(n)+ . . . +x(n−m)a*ₘ(n)
in which x*(n+1) is a predicted value of the future data value x(n+1);
setting
γₗ(n+1)=γₗ₊₁(n)=x(n+1)x(n+2−l)
for l=1, 2, . . . , m;
determining a predicted process parameter a*₀(n) as
$${a}_{0}^{*} ( n ) = [ \frac{{\sum }_{i = 0}^{n - k} [ x ( n - i ) d ( n + 1 - i ) ] - {\sum }_{j = 1}^{m} ( {\sum }_{i = 0}^{n - k} [ x ( n - i ) d ( n + i - j ) ] )}{{\sum }_{i = 0}^{n - k} x ( n - i )} ] ;$$
and
determining a predicted data point at (n+1) as:
$${d}^{*} ( ( n + 1 ) / n ) = {a}_{0}^{*} ( n ) + {\sum }_{j = 1}^{m} d ( n + 1 - j ) {a}_{j}^{*} ( n ) .$$

12. The article according to claim 11, wherein the data set comprises financial portfolio data of a portfolio,
the method further comprising:
setting a desired future value of the portfolio at time (n+1) to be y_{d}(n+1);
setting a forecasted value of a data point of an entity in the portfolio to be d*ₚ((n+r)/n) for p=1, 2, . . . , P, and r=1, 2, . . . , R, in which R is selected to be greater than
setting a weighting of each entity in the portfolio to be wₚ(n) for p=1, 2, . . . , P;
setting a current value of the portfolio at instance n to be
$$I ( n ) = {\sum }_{p = 1}^{P} {d}_{p} ( n ) {w}_{p} ( n ) ;$$
determining a desired portfolio value to be I_{d}((n+r)/n)=I(n)e^{arδt} in which δt is a time interval between data samples, and α is an interest rate; and
optimizing the entities in the portfolio as
$$[ \begin{matrix}{I}_{d} ( ( n + 1 ) / n ) \\ {I}_{d} ( ( n + 2 ) / n ) \\ ⋮ \\ {I}_{d} ( ( n + R ) / n )\end{matrix} ] = [ \begin{matrix}{d}_{1}^{*} ( ( n + 1 ) / n ) & {d}_{2}^{*} ( ( n + 1 ) / n ) & … & {d}_{p}^{*} ( ( n + 1 ) / n ) \\ {d}_{1}^{*} ( ( n + 2 ) / n ) & {d}_{2}^{*} ( ( n + 2 ) / n ) & … & {d}_{p}^{*} ( ( n + 2 ) / n ) \\ ⋮ & ⋮ & ⋮ & ⋮ \\ {d}_{1}^{*} ( ( n + R ) / n ) & {d}_{2}^{*} ( ( n + R ) / n ) & … & {d}_{p}^{*} ( ( n + R ) / n )\end{matrix} ] [ \begin{matrix}{w}_{1} ( n + 1 ) \\ {w}_{2} ( n + 2 ) \\ ⋮ \\ {w}_{p} ( n + R )\end{matrix} ]$$
or as
I((n+1)/n)=[D*((n+1)/n)]wₚ(n+1)
determining an optimal weight w*ₚ(n+1) for each entity in the portfolio as
w*ₚ(n+1)=[D*^{T}((n+1)/n)D*((n+1)/n)]⁻¹D*^{T}((n+1)/n)I((n+1)/n).

13. The article according to claim 12, wherein the data set comprises financial portfolio data.

14. The article according to claim 11, wherein the data set comprises financial portfolio data.

15. The article according to claim 11, wherein the data set comprises seismic data.
